(19) United States
(12) Patent Application Publication
(10) Pub. No.: US 2017/0261972 A1
(43) Pub. Date: Sep. 14, 2017

(54) Monitoring means and monitoring method for monitoring at least one step of a process run on an industrial site

(71) Applicant: Endress + Hauser Messtechnik GmbH + Co. KG, Weil am Rhein (DE)

(72) Inventors: Dimitri Vaissiere, Rixheim (FR); Markus Nick, Kembs (FR)

(73) Assignee: Endress + Hauser Messtechnik GmbH + Co., KG, Weil am Rhein (DE)

(21) Appl. No.: 15/514,856

(22) PCT Filed: Aug. 19, 2015
(86) PCT No.: PCT/EP2015/069076

§ 371 Date: Mar. 28, 2017

(30) Foreign Application Priority Data
Sep. 30, 2014 (EP) 1 418 703.1

(51) Int. Cl. G05B 23/02

(52) U.S. Cl. CPC G05B 23/0275; G05B 23/0243; G05B 23/027

(57) ABSTRACT

Monitoring structure and a monitoring method for monitoring at least one step of a process performed on an industrial site is described, which allows prompt, reliable and efficient detection of disturbances based on readily available information, provided by the measurement results of the measurement devices involved in the performance of the step, and determined based on a model of the step, comprising primary models for the measurement devices comprising a basic function representing a time dependency of the measurement results of the device, a first property determined by best fitting the basic function to the measurement results obtained by the respective measurement device, a secondary model for each of the primary models, each comprising a second property given by a dispersion of residues between the measurement results obtained by the respective measurement device and the corresponding fitted function, and tertiary models for those pairs of measurement devices, which render correlated measurement results during faultless performance of the respective step, each tertiary model comprising a third property, given by a degree of correlation between simultaneously obtained measurement results of the respective pair of measurement devices during performance of the respective step, and a reference range for each of the properties, comprising a range within which the respective property is expected to occur during faultless performance of the step.

The present invention concerns monitoring means and a monitoring method for monitoring at least one step of a predefined process run on an industrial site for performing said process comprising means for running said process on said site, including a control unit controlling initiation and performance of the steps of said process, and measurement devices involved in the performance of the steps for measuring process related quantities.

Industrial sites designed to perform predefined processes, e.g. production processes, are used in nearly all branches of industry.

Industrial production sites are quite often very complex and comprise means for running the process on the site, including a control unit controlling initiation and performance of the steps of process and a multitude of measurement devices for measuring quantities related to each of the steps, as well as manually or automatically operated appliances, such as pumps, valves or switches, and passive components, like for example pipes or containers.

Examples of measurement devices are level measurement devices e.g. for measuring a level of a product in a container, pressure measurement devices e.g. for measuring a pressure inside a container, flow meters for measuring a flow through a pipe, or temperature measurement devices e.g. for measuring a temperature of an intermediate product during production or processing. Measurement results of these measurement devices are commonly used in process automation for monitoring and/or controlling the process performed on the site, e.g. in order to ensure, that the product produced meets the requirements specified for it. Thus it is necessary to ensure, that the measurement devices applied for monitoring and controlling the process operate properly.

In order to minimize down times due to disturbances occurring on the site, industrial sites are maintenanced, and measurement devices are regularly maintenanced and/or or calibrated. In addition predictive maintenance schemes, criticality analysis, and/or failure mode cause and effect analysis (FMECA) can be applied.

Obviously there is a strong desire to operate industrial sites safely and profitably. In consequence there is a need in industry, to discover any disturbance occurring during a performance of the process, to determine its root cause, and to find and apply an appropriate remedy as soon as possible.

Obviously disturbances can be due to a multitude of different root cause, e.g. root causes related to the measurement devices, the appliances or the passive components, ranging from top end measurement devices equipped with means for self-monitoring, self-diagnosing and self-verification of their performance to non-monitored manually operated appliances or passive components, like for example pipes or valves. Thus detecting a disturbance, determining its root cause and finding an appropriate remedy may require dealing with a large number of different devices from different manufacturers. In consequence monitoring, maintenance, and quality control of an industrial site is very complex, and requires inputs from a very large number of different sources.

This makes it very difficult to detect disturbances at an early stage. Quite often a disturbance is only recognized after completion of the entire process, when the end product produced is found not to be compliant to the quality standards required for it.

One method of trying to detect disturbances at an early stage is described in EP 1 725 919 B1. This method is based on statistical process monitoring performed based on statistical measures, such as a mean or a variance, determined from process variables, e.g. measurement results, collected by field devices, like for example measurement devices, valves, switches, transmitters or sensors. The method may include determination of statistical distributions of process variables and correlations between two variables.

In order to monitor a complex site based on statistical process monitoring it is necessary, to determine the process variables available for this purpose, to identify and determine the appropriate statistical measures to be applied for them, and to foresee means for collecting the corresponding statistical data.

To this extend, the method described in EP 1 725 919 B1, foresees an analysis of the site to be performed, in order to determine a plurality of statistical parameters, to be generated by a plurality of statistical data collection blocks implemented in a plurality of field device communicatively coupled to a network, in order to enable the plurality of field device to provide the plurality of statistical parameters to a statistical data collection system via the network.

Obviously, the determination of process variables available for statistical process monitoring and the identification and determination of the appropriate statistical measures to be applied for them, is not an easy task, and many field devices may not have implemented statistical data collecting blocks.

It is an object of the invention to provide monitoring means and a monitoring method for monitoring at least one step of a process performed on an industrial site, which allows prompt, reliable and efficient detection of disturbances based on readily available information.

To this extent, the invention comprises monitoring means, for monitoring at least one step of a predefined process performed on an industrial site comprising means for running said process on said site, including a control unit controlling initiation and performance of steps of said process, and measurement devices involved in the performance of the steps for measuring process related quantities, comprising:
a monitoring unit designed to be set up and connected such, that it has real-time access to measurement results obtained by the measurement devices involved in the performance of the steps to be monitored and the times at which they were obtained in relation to a starting time at which performance of the respective process step was started during the respective run, comprising:
   a memory storing a model for each step to be monitored, each model comprising:
a) a primary model for at least some, in particular all measurement devices involved in the performance of the respective step, each comprising:
   a basic function of time and a set of coefficients representing a time dependency of the measurement results of the respective measurement device to be expected during faultless performance of the step,
   a first property given by a set of fitted coefficients determined by best fitting the basic function to the measurement results obtained by the respective measurement device during a performance of the step, and a reference range for the first property,
b) a secondary model for each of the primary models, each comprising a second property given by a dispersion of residues between the measurement results obtained by the respective measurement device during a performance of the step and the corresponding fitted function, and a reference range for the second property, and
c) tertiary models for pairs of measurement devices involved in the performance of the step, which render correlated measurement results during faultless performance of the step, each tertiary model comprising a third property, given by a degree of correlation between simultaneously obtained measurement results of the respective pair during performance of the respective step, and a reference range for the third property
   wherein each of the reference ranges comprises a range for the respective property within which the respective property is expected to occur during faultless performance of the step, and
      computing means for determining the properties pertinent to the primary, secondary and tertiary models based on the measurement results obtained by the measurement devices involved in the performance of the monitored steps during monitored runs of the process, and for detecting a fault, in case at least one of these properties exceeds the corresponding reference range.

The invention further comprises a first method of determining a model of a step of a process stored in the monitoring unit according to the invention, comprising the steps of:
performing a number of test runs of the process and determining whether a result produced by the respective test run is compliant to predefined quality requirements,
recording the measurement results obtained by measurement devices involved in the performance of the respective step together with the times at which they were obtained in relation to a starting time at which the respective process step was started during the respective test run for all test runs, for which compliancy to the quality requirements was determined, as performed reference runs,
determining the primary, secondary and tertiary models based on the measurement results of a population of reference runs, comprising the performed reference runs or the performed reference runs and simulated reference runs, obtained by simulations performed based on the measurement results of the performed reference runs, which generate measurement results of the measurement devices to be expected during faultless performance of the step.

A refinement of the first method, further comprises the steps of determining each primary model by:
determining the basic function, based on the time dependency of the measurement results obtained by the respective measurement devices during performance of the respective step during the reference runs,
determining the reference range for each first property by
   determining a set of fitted coefficients for each reference run by best fitting the respective basic function to the measurement results obtained by the respective measurement device during performance of the step during the respective reference run,
   based on a distribution of the determined sets of fitted coefficients, determining a probability of a first property determined during a monitored run to belong to this distribution, and
   determining the reference range such, that it includes all first properties, for which the probability to belong to the distribution is larger than or equal to a predetermined probability threshold.

A further refinement of the first method, comprises the steps of determining the reference range for each of the second properties by, for each reference range
determining a dispersion of residues between the measurement results obtained by the respective measurement device during performance of the step during one of the reference runs and the corresponding fitted function determined for this measurement device for this reference run for each of the reference runs,
based on all determined dispersion of residues determining a probability distribution representing the probabilities of residues to occur during faultless performance of the step as a function of their size, and
determining the reference range such, that it includes all second properties, for which the probability to belong to the corresponding probability distribution is larger than or equal to a predetermined probability threshold, in particular by determining the reference as a range for a variance of the residues of the dispersion of residues.

A further refinement of the first method, comprises the steps of:
identifying pairs of measurement devices involved in the performance of the step which render correlated measurement results during faultless performance of the step, in particular identifying them by
   for each possible pair of measurement devices involved in the performance of the step determining a degree of correlation between their simultaneously obtained measurement results during performance of this step for each reference run, and
identifying the pairs rendering correlated measurement results based on the degrees of correlations determined for all possible pairs for all reference runs, and
for each identified pair, determining the reference range for the respective third property such, that it includes all respective third properties, for which the probability to belong to a reference distribution given by a distribution of the corresponding degrees of correlations determined for the respective pair for the reference runs is larger than or equal to a predetermined probability threshold.

The inventions further comprises a second method of monitoring performance of a step of a predefined process performed on the industrial site comprising means for running said process on said site, including a control unit controlling initiation and performance of steps of said process, and measurement devices involved in the performance of the steps for measuring process related quantities, and monitoring means according to invention, having real-time access to measurement results obtained by the measurement devices involved in the performance of the steps to be monitored and the times at which they were obtained in relation to a starting time at which performance of the respective process step was started during the respective run, comprising the steps of:
recording the measurement results obtained by the measurement devices involved in the performance of the step during performance of the step,
based on the recorded measurement results determining the properties pertinent to the primary, secondary and tertiary models of the respective step, and
detecting a fault, in case at least one of the properties exceeds the corresponding reference range.

A refinement of the second method comprises the step of indicating a warning in case at least one of the determined properties occurred in a range, which according to a distribution of the respective property, to be expected during faultless performance of the step, in particular a corresponding distribution of sets of fitted coefficients, a corresponding probability distribution of residues and a corresponding reference distribution of the degrees of correlation, has a low probability of occurring.

The invention further comprises a third method of determining an impact of a disturbance of a certain type on the properties of the model for a step of the process monitored by the monitoring unit according to the invention, comprising the step of:
recording measurement results of the measurement devices involved in the performance of the step, during disturbed runs of the process step, during which a disturbance of this type has been voluntarily induced, and/or generating corresponding measurement results to be expected during performances of this step suffering from the respective disturbance by numerical simulations,
determining disturbed primary, secondary and tertiary models in the same way as the primary, secondary and tertiary models representing the faultless performance of the respective step were determined based on recorded and/or generated measurement results of a population of disturbed runs suffering from disturbances of the same size and type,
repeating the determination of the disturbed primary, secondary and tertiary models for increasing sizes of the same type of disturbance,
determining the impact of the type of disturbance on the properties of the model by comparing the distributions of the properties, in particular the distributions of the sets of fitted coefficients, the probability distribution of the residues and the reference distributions of the degrees of correlation, determined based on the measurement results of the reference runs to the corresponding distributions of the same properties determined based on the measurement results of the disturbed runs.

A refinement of the second method comprises the steps of:
validating performances of monitored steps during which no fault was detected,
in particular validating them with a reliability determined based on a confidence level for detecting a fault, in case a disturbance of a certain type and this size or larger is present, and/or a probability of not detecting a fault, even though a disturbance of a certain type and this size is present, determined for one or more disturbances,
   for which disturbances their impact on the properties has been determined based on the method according to third method, and
   for which disturbances the confidence level and/or the probability has been determined based on the distributions of the properties determined based on the measurement results of the disturbed runs suffering from increasing sizes of disturbances of this type and the reference ranges for the monitored properties.

A refinement of the last mentioned refinement comprises the steps of:
storing the measurement results obtained during validated performances, and
updating the model stored in the monitoring unit based on measurement results of validated performances of the respective step.

Further the invention comprises a diagnosing unit for performing diagnoses regarding faults detected by the monitoring means according to the invention, comprising a data base for storing data sets related to known types of disturbances, which can occur during performance of one of the steps for which a model is stored in the memory of the monitoring unit, wherein each data set comprises the type of disturbance, and its impact on each of the monitored properties determined by the third method.

According to a refinement of the diagnosing unit according to the invention at least one data set comprises:
a list of at least one root cause, causing the respective disturbance,
in particular a list of at least one root cause and a list of at least one action for at least one of the listed root causes, in particular an action directed towards the determination, whether the respective root cause is present, and/or an action given by a remedy suitable of resolving the respective root cause.

The invention further comprises a fourth method of performing a diagnosis regarding a fault detected by monitoring means according to the invention on an industrial site comprising a diagnosing unit according to the invention, comprising the steps of:
searching the data base for data sets stored for disturbances, which have an impact on the individual properties, which matches the properties determined for the present faulty performance of the respective step of the process, and
in case at least one matching disturbance is found,
   determining the root causes stored in the respective data sets, as possible root causes, which may have caused the detected fault, and
   performing the diagnosis based on the determined possible root causes.

The invention further comprises a fifth method of performing a diagnosis regarding a fault detected by monitoring means according to the invention on an industrial site comprising a diagnosing unit according to the invention, comprising the steps of:
searching the data base for data sets stored for disturbances, which have an impact on the individual properties, which matches the properties determined for the present faulty performance of the respective step of the process, and
in case no matching disturbance is found,
   determining in which direction the properties, which exceeded the corresponding reference range, exceeded the corresponding reference range,
   for each property, for which the direction in which it exceeded the corresponding reference range, was determined, searching the data base for disturbances which cause the same property to exceed this reference range in the same or a similar direction,
   determining the root causes stored in the data sets of the disturbances, which cause the respective properties to exceed the corresponding reference range in the same direction, as possible root causes, and
performing the diagnosis based on the determined possible root causes.

The invention further comprises a sixth method of performing a diagnosis regarding a fault detected by monitoring means according to the invention on an industrial site comprising a diagnosing unit according to the invention, comprising the steps of:
in case the first or the second property determined for one of the measurement devices involved in the performance of the step exceeded the corresponding reference range and one of the third properties related to a tertiary model pertinent to the same measurement device shows a reduced degree of correlation diagnosing a disturbance pertinent to this measurement device, and/or
in case the first or the second property determined for one of the measurement devices involved in the performance of the step exceeded the corresponding reference range and none of the third properties related to a tertiary model pertinent to the same measurement device shows a reduced degree of correlation diagnosing a disturbance affecting the quantity measured by this measurement device.

The invention further comprises a further development of the fourth, fifth or the sixth method performed on an industrial site comprising a diagnosing unit according to the invention, wherein
additional information is stored in the data base,
in particular information on additional disturbances, root causes, actions related to root causes and/or additional diagnostic information, in particular rules for determining root causes, diagnosing tools and/or diagnosing methods, and
the additional information is applied during performance of the diagnosis, in particular in order to determine the disturbance and/or the root cause that caused the detected fault.

A refinement of the fourth method or the last mentioned further development of performing a diagnosis regarding a fault detected by monitoring means according to the invention on an industrial site comprising a diagnosing unit according to the invention, comprises the step of: determining the root cause of the detected fault based on the determined possible root causes and the actions directed towards the determination of their presence stored in the data base, by performing the actions in an order, in particular an order recommended by the diagnosing unit, corresponding to their availability and the time and cost involved in their performance, in particular by having at least one of those actions, which can be performed in an automated fashion on the site, performed in an automated fashion based on a corresponding request issued by the diagnosing unit and/or by having at least one of those actions initiated and/or performed by an operator of the site.

A refinement of the fourth method or the last mentioned further development, comprises the steps of:
determining the root cause, that caused the presently detected fault,
applying a remedy to resolve the root cause, and
during a verification time interval monitoring consecutive performances of the step of the process, and
validating the applied remedy, in case no further fault was detecting during performances of the respective step during the verification time interval.

The invention further comprises a method of amending the data base of the diagnosing unit according to the invention, by
adding at least one data set related to a disturbance, which had occurred on the site and was subsequently identified, in particular a data set comprising an impact of this disturbance on the properties, in particular an impact determined by the third method,
adding at least one root cause, causing one the disturbances contained in the data base, in particular root causes identified by the operator during operation of the site,
adding at least one action related to one of the root causes listed in the data base, in particular an action identified by the operator during operation of the site,
for at least one property measured by one of the measurement devices adding a list of at least one root cause, in particular a list of at least one root cause and list of at least one action related to one of the root causes, affecting this measured property, and/or
for at least one of the measurement devices, adding a list of at least one root cause, in particular a list of at least one root cause and list of at least one action related to one of the root causes, causing an impairment of this measurement device.

The invention and further advantages are explained in more detail using the figures of the drawing, in which one exemplary embodiment is shown. The same reference numerals refer to the same elements throughout the figures.

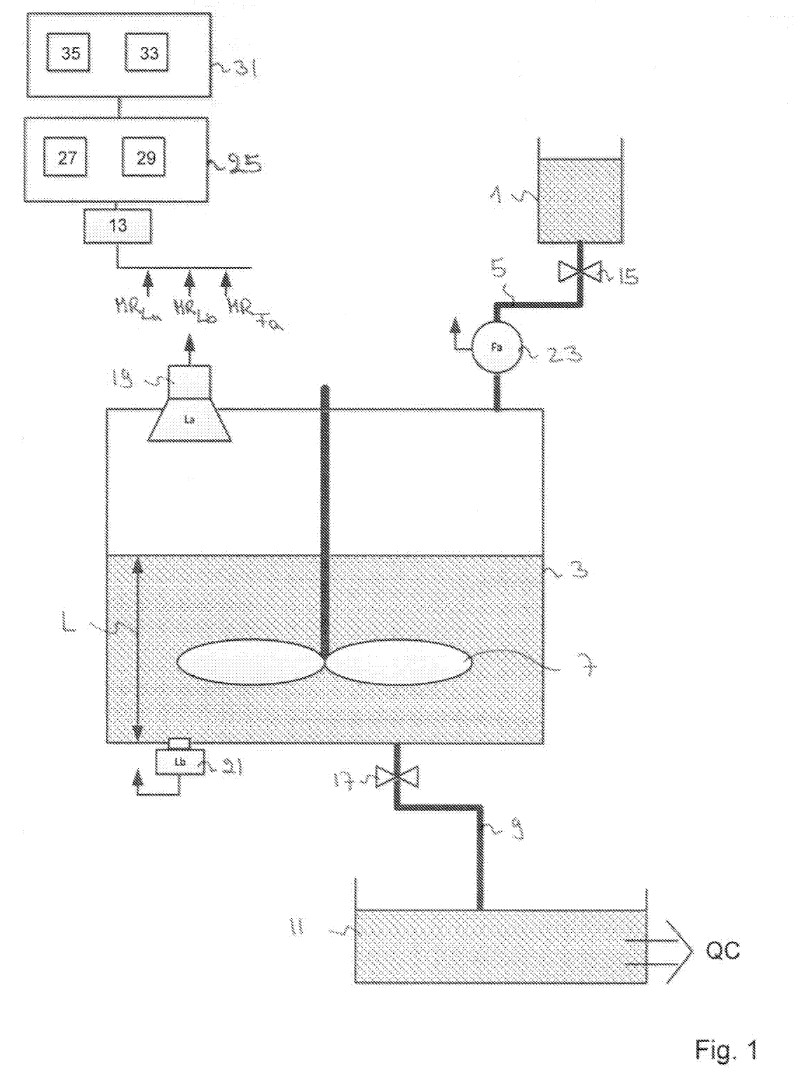

FIG. 1 shows: an example of an industrial site for performing a predefined process;

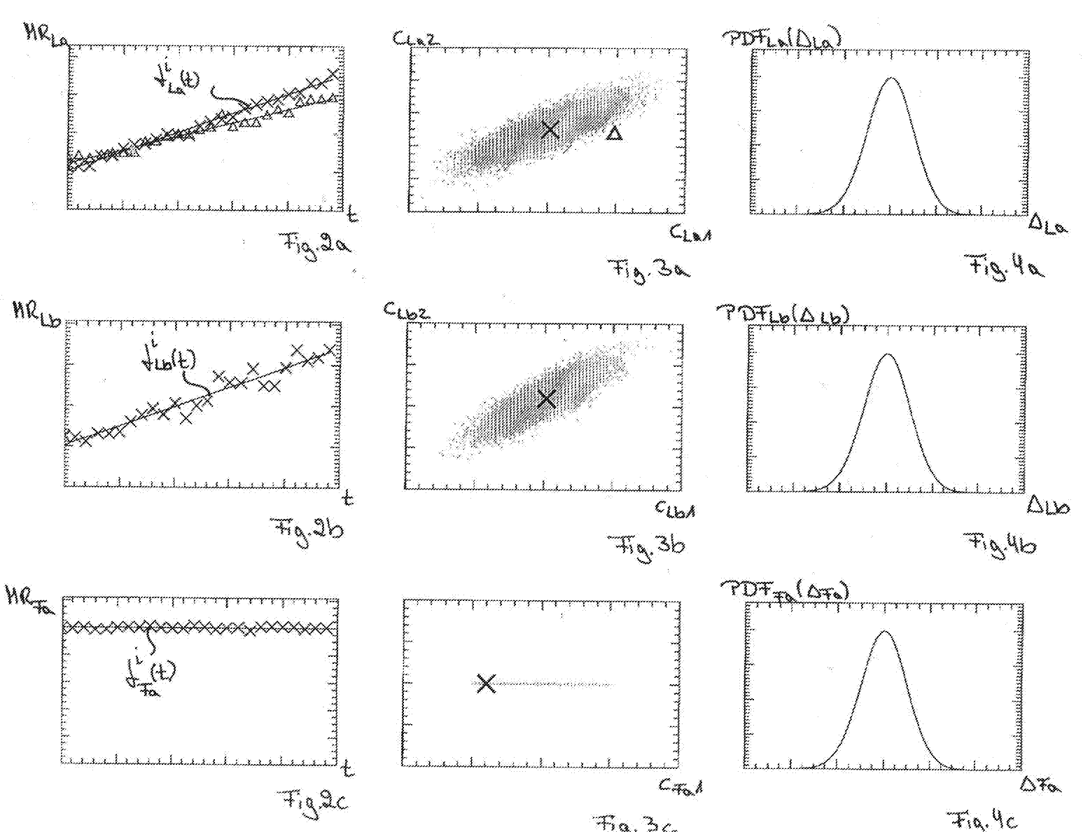

FIG. 2a-c show: measurement results obtained by the first level measurement device, the second level measurement device and the flow meter of FIG. 1 during performance of a first step during a reference run and corresponding fitted functions;

FIG. 2d-e show: measurement results obtained by the first level measurement device and the second level measurement device of FIG. 1 during performance of a second step during a reference run corresponding fitted functions;

FIG. 3a-e show: the sets of fitted coefficients of the corresponding fitted functions shown in FIG. 2a-e and corresponding reference ranges;

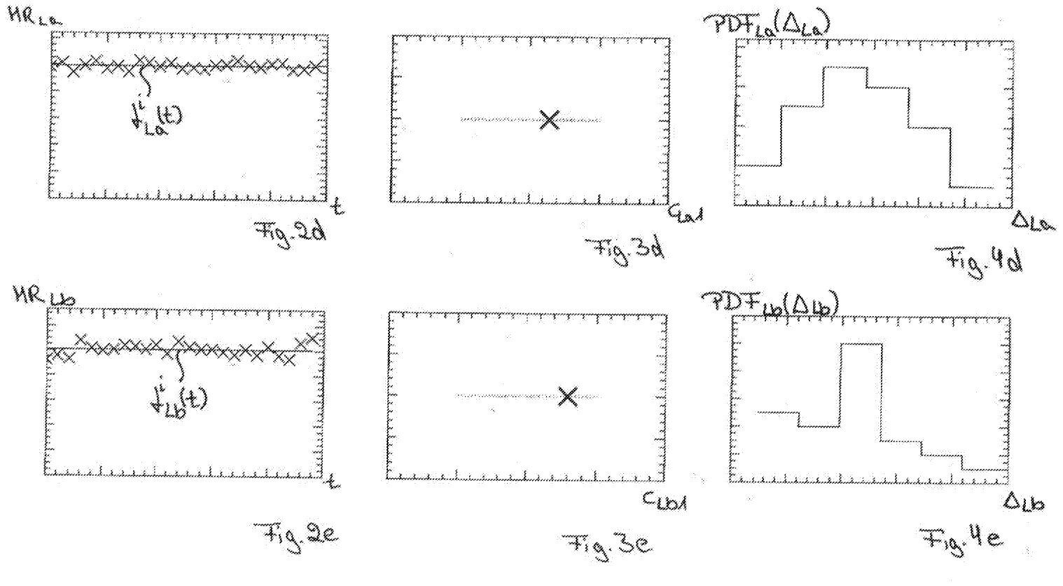

FIG. 4a-c show: probability distributions of residues between measurement results of the first level measurement device, the second measurement device and the flow meter of FIG. 1 and the corresponding fitted functions for the first step;

FIG. 4d-e show: probability distributions of residues between measurement results of the first and the second level measurement device of FIG. 1 and the corresponding fitted functions for the second step;

FIG. 5 shows: measurement results of the first level measurement device as a function of simultaneously obtained measurement results of the second level measurement device obtained during faultless performances of the first step;

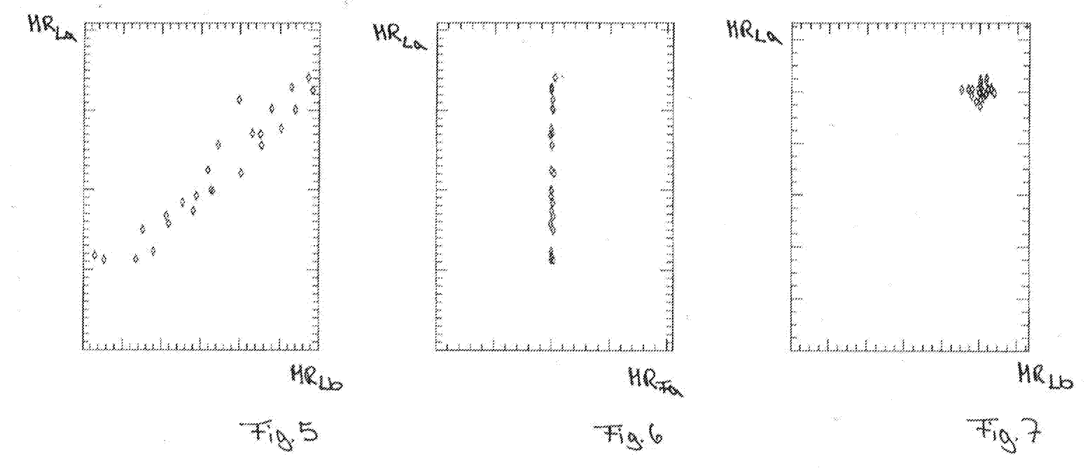

FIG. 6 shows: measurement results of the first level measurement device as a function of simultaneously obtained measurement results of the flow meter obtained during faultless performances of the first step; and

FIG. 7 shows: measurement results of the first level measurement device as a function of simultaneously obtained measurement results of the second level measurement device obtained during faultless performances of the second step.

The invention concerns monitoring means for monitoring at least one step of a predefined process performed on an industrial site designed to perform the predefined process and a method of monitoring at least one step of the process performed on the site. In general the industrial site comprises means for running the process on said site, including a control unit controlling initiation and performance of the steps of the process, measurement devices MD for measuring quantities related to each of the steps, manually or automatically operated appliances, like for example pumps, valves or switches, and passive components, like for example pipes or containers. Obviously, industrial sites can be very complex and the processes performed by them can involve a large number of steps. In order to make the invention more easy to understand, it is explained based on a very simple process including a first step of filling a component into a container and a second step of agitating the content of the container. The invention can however be applied in the same way to much more complex sites performing much more complex processes.

At the beginning, the process to be performed on the site is defined, and individual steps of the process are identified. In order to perform the above mentioned simple process, the site shown in FIG. 1 comprises a supply tank 1 containing the component, which is connected to a container 3 via an inlet pipe 5. The container 3 is equipped with an agitator 7, and an outlet pipe 9 is foreseen, connecting the container 3 to a receptacle 11. The site further comprises a control unit 13 controlling initiation and performance of the steps of the process. The control unit 13 can for example be a programmable logical controller (PLC) connected to the measurement devices MD and the automatically operated appliances, e.g. pumps or valves, which controls the appliances based on the measurement results MR_{MD} obtained from the measurement devices MD.

In the embodiment shown in FIG. 1, the inlet pipe 5 and the outlet pipe 11 are equipped with a valve 15, 17, which can either be operated manually or be opened and closed by the control unit 13 via corresponding actuators.

The measurement devices MD foreseen in the present example comprise a first level measurement device 19, installed on top of the container 3 for measuring the filling level L inside the container 3. This can for example be a radar time of flight level measurement device. In addition a second level measurement device 21 is foreseen. The second level measurement device 21 comprises for example a pressure sensor measuring a hydrostatic pressure indicative of the level L, which is positioned at the bottom of the container 3. In addition a flow meter 23 is foreseen in inlet pipe 5 for measuring a mass or volume flow flowing through the inlet pipe 5.

According to the invention, monitoring means for monitoring at least one step of the process are foreseen, comprising a monitoring unit 25 which is designed and connected up in such a way, that it has real-time access to the measurement results MR_{MD} obtained by at least some, preferably all of the measurement devices MD involved in the performance of the steps of the process to be monitored by it. To this extend the monitoring unit 25 can be connected to the measurement device MD involved in the performance of the steps to be monitored directly, e.g. via a bus line, or it can be provided with the measurement results MR_{MD} and the measurement times tⱼ at which they were measured via the control unit 13, which is connected to the measurement devices MD, e.g. via a bus line. The later alternative is shown in FIG. 1.

In addition means are foreseen, for enabling the monitoring unit 25 to relate the times tⱼ at which the measurement results MR_{MD}(tⱼ) are obtained to a starting time t₀, at which performance of the respective step of the process was started during the respective run. Since the control unit 13 initiates the performance of each step, this information is readily available within the control unit 13, and can be provided to the monitoring unit 25 by it.

The monitoring unit 25 comprises a memory 27 and computing means 29, e.g. a microprocessor or another type of signal processing or computing unit, designed to run software provided to it using input data supplied to it by the measurement devices MD, the control unit 13 and the memory 27. The monitoring unit 25 is set up to monitor at least one step, preferably all steps of the process, based on the measurement results MR^{PR}(tⱼ) obtained during performance of the respective step by at least two, preferably all measurement devices MD involved in the performance of the respective step and the times tⱼ at which they were obtained in relation to the starting time to at which the respective step was started during each monitored run of the process.

Monitoring of a step is performed based on properties K to be determined based on the measurement results MR(tⱼ) obtained by the measurement devices MD involved in the performance of this step during the monitored performance of the step. The properties K are determined by the monitoring unit 25, and compared to corresponding predetermined reference ranges R_{K}, each comprising a range for the respective property K, within which the property K is expected to occur during faultless performance of the step. In case at least one property K exceeds at least one upper or lower limit given by the corresponding reference range R_{K} a fault is detected by the monitoring unit 25.

The properties K to be determined and the corresponding reference ranges R_{K} are determined based on a model of the respective step, which is determined during a preparatory phase and subsequently stored in the memory 27 of the monitoring unit 25.

During the preparatory phase test runs of the process are performed on the site. During each test run, the measurement results MR_{MD}(tⱼ) obtained by the measurement devices MD involved in the performance of the respective step of the process are recorded throughout the performance of the step together with the times tⱼ at which they were obtained during the performance of the respective step. This is preferably done for all steps of the process. For each process step, the times tⱼ at which the recorded measurement results MR_{MD}(tj) were obtained by the measurement devices MD involved in this particular step are based on a time scale beginning with a starting time to, at which the respective process step was started during the respective test run.

At the end of each test run quality control means QC are applied, in order to determine, whether the result produced by the respective test run is compliant to predefined quality requirements. Depending on the type of process performed, quality control means can range from simple visual inspections performed on site, to extensive testing procedures, which can be performed manually and/or by fully automated quality control apparatuses.

If the produced result is compliant, the test run is validated, and the measurement results MRⁱ_{MD} (tⱼ) and the times tⱼ at which they were measured during the validated test run are stored in the memory 27 of the monitoring unit 25 as a performed reference run. For each performed reference run faultless performance of the process is assumed, and properties K derived based on the measurement results MRⁱ_{MD} (tⱼ) of the performed reference runs are assumed to be representative of faultless performance of the step.

Once a number m, larger or equal to a predetermined minimal number mₘᵢₙ, e.g. a minimal number of mₘᵢₙ=5, of performed reference runs, have been recorded, a model set up for each step of the process to be monitored, and the reference ranges R_{K} for the properties K are determined.

The accuracy of the model of a step can be improved by increasing the number of performed reference runs available for its determination. In addition or instead, simulations can be performed based on the measurement results of the recorded number of performed reference runs, generating measurement results of a larger number of simulated reference runs. Based on a sufficiently large population of reference runs RRi, comprising performed reference runs or performed and simulated reference runs, each model set up for a step of the process will render a precise representation of the properties K of the measurement results MR_{MD} of the measurement devices MD to be expected during faultless performance of the respective step.

The measurement devices MD involved in the first step of the process described above are the flow meter 23 generating measurement results MR_{Fa} of the flow of the first component flowing into the container 3, the first level measurement device 19 generating measurement results MR_{La} of the level L inside the container 3, and the second level measurement device 21 generating measurement results MR_{Lb} of the level L inside the container 3. The measurement devices MD involved in the second step include the first and the second level measurement devices 19, 21.

FIGS. 2a, 2b and 2c show the measurement results MR_{La}ⁱ(tⱼ), MRⁱ_{Lb}(tⱼ), MRⁱ_{Fa}(tⱼ) of the first level measurement device 19, the second level measurement device 21, and the flow meter 23 as a function of the time tⱼ at which they were measured during performance of the first step during the i-th reference run RRᵢ. FIGS. 2d and 2e show the measurement results MR_{La}ⁱ(tⱼ) MRⁱ_{Lb}(tⱼ) of the first and the second level measurement device 19, 21 as a function of the time tⱼ at which they were measured during performance of the second step during the i-th reference run RRᵢ. In each of the FIGS. 2a-2e the measurement results MR_{La}ⁱ(tⱼ), MRⁱ_{Lb}(tⱼ), MRⁱ_{Fa}(tⱼ) of the respective measurement device 19, 21, 23 are indicated by crosses.

According to the invention, each model set up for a step of the process comprises primary, secondary and tertiary models.

Primary models are set up for at least one, preferably for all measurement devices MD involved in the performance of the step to be monitored. Each primary model represents a time dependency of the measurement results MR_{MD} of the respective measurement device MD to be expected during faultless performance of the step. This time dependency is determined for each measurement device MD involved by determining a basic function f_{MD}(t; C_{MD}) of time t and a set of coefficients C_{MD} comprising one or more coefficients c_{MD1}, . . . , c_{MDk}, representing the time dependency of the measurement results MR_{MD} of the respective measurement device MD during performance of the respective step to be expected during faultless performance of the respective step. Since faultless performance of the step is assumed for all reference runs RRi, the basic functions f_{MD}(t; C_{MD}) can be determined solely based on the measurement results MRⁱ_{MD}(tⱼ) obtained by the respective measurement device MD during performance of the respective step during the reference runs RRᵢ. To this extend known mathematical methods for determining functional dependencies can be applied to the find the type of function, which best represents the time dependency exhibited during the reference runs RRᵢ. These methods are preferably implemented in software, which is run on the computing means 29. Depending on the type of process step and the measurement device MD concerned, the most suitable basic function f_{MD}(t, C_{MD}) can e.g. be a polynomial of a given order, an exponential function, a logarithmic function, or any other mathematical function of time.

In case the time dependency to be expected of the measurement results MR_{MD} of a certain measurement device MD involved in this step is known, due to further knowledge about this step, this known time dependency can be used to determine the basic function f_{MD}(t, C_{MD}), instead.

In the present example, the container 3 is cylindrical and the component is supplied by a pump operating at a constant pumping rate.

In consequence the flow F through the first inlet pipe 7 is expected to be constant and the level L inside the container 5 is expected to rise linearly with time throughout the performance of the first step. Thus a constant basic function f_{Fa}(t) c_{Fa1} having a set of only one coefficient c_{Fa1} representing the constant flow, is most suitable to describe the time dependency of the measurement results MR_{Fa}(tⱼ) of the first flow meter 29 during performance of the first step. Correspondingly a linear basic function f_{La}(t)=c_{La1}+c_{La2} t; f_{Lb}(t)=c_{Lb1}+c_{Lb2} t having a set of two coefficients (c_{La1}, c_{La2}); (c_{Lb1}, c_{Lb2}) is most suitable to describe the time dependency of the measurement results MR_{La}(tⱼ) of the first level measurement device 19 and the measurement results MR_{Lb}(tⱼ) of the second level measurement device 21 during performance of the first step.

During proper performance of the second step of agitating the product, the level inside the container 3, will remain constant. Thus constant basic functions f_{La}(t)=c_{La1}; f_{Lb}(t)=c_{Lb1} having a set of only one coefficient (c_{La1}); (c_{Lb1}) are most suitable to describe the time dependency of the measurement results MR_{La}(tⱼ), MR_{Lb}(tⱼ) of the first and the second level measurement device 19, 21 during performance of the second step.

For each primary model, a first property K1 is defined, which is given by a set of fitted coefficients D_{MD} determined by best fitting the basic function f_{MD}(t; C_{MD}) determined for this measurement device MD to the measurement results MR_{MD} (tⱼ) obtained by the corresponding measurement device MD during a monitored performance of the respective step. The sets of fitted coefficients D_{MD} can for example be determined by minimizing the differences between the measurement results MR_{MD}(tⱼ) obtained by the respective measurement device MD during performance of the respective step during the respective run and the values V_{MD}(tⱼ)=f_{MD}(tⱼ; C_{MD}) rendered by the corresponding basic function f_{MD}(tⱼ; C_{MD}) of time t and the set of coefficients C_{MD} at the same time of measurement tⱼ, e.g. by applying the least square method.

Next for each first property K1 pertinent to one of the measurement devices MD involved in the performance of the step to be monitored, the corresponding reference range R_{K1} is determined. This is preferably done by determining a set of fitted coefficients Dⁱ_{MD} by best fitting the basic function f_{MD}(t; C_{MD}) to the measurement results MRⁱ_{MD} (tⱼ) obtained by the corresponding measurement device MD during the performance of the step for each of the reference runs RRi. Thus for each basic function f_{MD}(tⱼ; C_{MD}) a number of sets of fitted coefficients Dⁱ_{MD} is determined, which is equal to the number p of reference run RRi available.

FIG. 2a-2c show the fitted functions fⁱ_{La}(t)=dⁱ_{La1}+dⁱ_{La2} t; fⁱ_{Lb}(t)=dⁱ_{Lb1}−dⁱ_{Lb2} t; fⁱ_{Fa}(t)=dⁱ_{Fa} obtained by best fitting the measurement results MRⁱ_{La}(tⱼ); MRⁱ_{Lb}(tⱼ); MRⁱ_{Fa}(tⱼ) obtained by the first level measurement device 19, the second level measurement device 21 and the flow meter 23 during performance of the first step during the i-th reference run RRi to the respective basic function f_{La}(tⱼ, C_{La1}); f_{Lb}(tⱼ, C_{Lb1}); f_{Fa}(tj, C_{Fa}). In FIG. 3a-c the corresponding sets of fitted coefficients Dⁱ_{La1}=(dⁱ_{La1}, dⁱ_{La2}); Dⁱ_{Lb1}=(dⁱ_{Lb1}, dⁱ_{Lb2}); Dⁱ_{Fa}=(dⁱ_{Fa}) are indicated by a cross in a coordinate system defined by the coefficients (c_{La1}, c_{La2}); (c_{Lb1}, c_{Lb2}); (c_{Fa}) of the respective basic function f_{La}(tⱼ, C_{La1}); f_{Lb}(tⱼ, C_{Lb1}); f_{Fa}(tj, C_{Fa}).

FIG. 2d-e show the fitted functions fⁱ_{La}(t)=dⁱ_{La1}; fⁱ_{Lb}(t)=dⁱ_{Lb1} obtained by best fitting the measurement results MRⁱ_{La}(tⱼ); MRⁱ_{Lb}(tⱼ) obtained by the first and the second level measurement device 19, 21 during performance of the second step during the i-th reference run RRi to the respective basic function f_{La}(tⱼ, C_{La1}); f_{Lb}(tj, C_{Lb1}). In FIG. 3d-e the corresponding fitted coefficient (dⁱ_{La1}); (dⁱ_{Lb1}) is indicated by a cross in a coordinate system defined by the coefficient (c_{La1}); (c_{Lb1}) of the corresponding basic function f_{La}(tⱼ, C_{La1}); f_{Lb}(tj, C_{Lb1}).

For each measurement device MD, each of the determined sets of fitted coefficients Dⁱ_{MD} comprises a fixed number of k fitted coefficients (dⁱ_{MD1}, . . . , dⁱ_{MDk}), forming a point in a k-dimensional space opened by the coefficients (c_{MD1}, . . . , c_{MDk}) of the corresponding basic function f_{MD}(tⱼ, C_{MD}). Together, the sets of fitted coefficients Dⁱ_{MD} determined for a measurement device MD for each of the reference runs RRi form a k-dimensional distribution, which is located in a limited coefficient region of the k-dimensional space, indicated by gray dotted areas in FIGS. 3a-e. Since the sets of fitted coefficients Dⁱ_{MD} are determined based on the measurement results MRⁱ_{MD} of the reference runs RRi, the sets of fitted coefficients Dⁱ_{MD} exhibit a distribution in this k-dimensional coordinate system, which is representative of faultless performance of this step.

For each measurement device MD involved, the reference range R_{K1} for the respective first property K1 is determined based on the distribution of the sets of fitted coefficients Dⁱ_{MD} determined for this measurement device MD for each of the reference runs RRi. Each reference range R_{K1} is preferably determined based on a probability of a first property K1, given by the corresponding set of fitted coefficients D_{MD}, determined during a monitored run to belong to the distribution of the corresponding sets of fitted coefficients Dⁱ_{MD} representing faultless performance of the respective step.

For each primary model, it is preferably determined whether the distribution of the sets of coefficients Dⁱ_{MD} is a Gaussian distribution. To this extent known normality tests can be applied, which can be implemented in software to be performed by the monitoring unit 25. If the distribution is Gaussian, the probability of a respective first property K1 to belong to this distribution is preferably determined as a Mahalanobis distance following a chi-square distribution. If the distribution of the sets of coefficients Dⁱ_{MD} is found not to be a Gaussian distribution, an isoprobabilistic data transformation is preferably performed, transferring the sets of fitted coefficients Dⁱ_{MD} determined for all the reference runs RRi into to a coordinate system, wherein they exhibit a Gaussion distribution. In this coordinate system the probability of a first property K1 to belong to the corresponding distribution representing faultless performance can then again be determined as a Mahalanobis distance.

Instead of the described method of determining the probability of a first property K1 to belong to respective distribution based on the Mahalanobis distance, alternative methods known in mathematics, in particular mathematical methods of testing a hypothesis of a data sample to belong to a given distribution, can be applied.

Each reference range R_{K1} is preferably determined such, that it includes all sets of fitted coefficients Dⁱ_{MD} for which the probability to belong to respective distribution of sets of fitted coefficients Dⁱ_{MD} representing faultless performance of the respective step is larger than or equal to a predetermined probability threshold. The probability thresholds defining the reference ranges R_{K1} are preferably chosen to best suit the requirements prevailing for the step and/or on the site, in particular the security requirements applicable to the site, as well as the financial risk involved in the performance of a process, which renders a production result, which is not compliant to the quality requirements specified for it. As a general rule lower probability thresholds are applied for steps and/or sites for which lower security requirements and lower financial risks are applicable, and higher probability thresholds are set for steps and/or sites for which higher security requirements or higher financial risks are applicable.

Each reference range R_{K1} can either be stored in the memory 27 as a limited coefficient region determined based on the probability threshold, or they can be stored in form of the probability threshold and software capable of determining the probability of a first property K1 determined for a monitored performance of the step to belong to the corresponding distribution of sets of fitted coefficients Dⁱ_{MD}.

In addition, the probability of a first property K1 determined during a monitored run of the process to belong to the corresponding distribution of sets of fitted coefficients Dⁱ_{MD} representing faultless performance of the respective step of the process can be used to classify the first property K1 according to its probability of occurrence during faultless performance of the step. In case it has a lower probability of occurrence during faultless performance, there is a correspondingly higher probability, that a gradual change occurred, which may eventually lead up to fault. In this case the monitoring unit 25 can be set up, to issue a corresponding warning.

Next a secondary model is set up for at least one, preferably all measurement devices MD involved in the performance of the step, for which a primary model has been set up. Each secondary model comprises a second property K2, given by a dispersion of the residues Δ_{MD} (tⱼ) between the measurement results MR_{MD} obtained during a performance of the step and the corresponding fitted function f_{MD}(t, D_{MD}). If for example j=1, . . . , n measurements are made at corresponding times tⱼ during a performance of the step, the dispersion comprises n residues Δ_{MD} (tⱼ), with j=1, . . . , n each given by:

Δ_{MD}(tⱼ)=MR_{MD}(tⱼ)−ƒ_{MD}(tⱼ;D_{MD})

wherein each residue Δ_{MD} (tⱼ) is given by the difference between the measurement result MR_{MD} (tⱼ) and the corresponding value rendered by the fitted function f_{MD}(tⱼ; D_{MD}) at the respective time of measurement tⱼ.

For each second property K2, the secondary model comprises a probability distribution PDF_{MD}(Δ_{MD}) of the residues Δ_{MD}, representing the probabilities of residues Δ_{MD} to occur during a faultless performance of the step, as a function of their size. Preferably not only the probability distributions PDF_{MD}(Δ_{MD}) of the residues Δ_{MD} to be expected during faultless performance of the step are determined, but also at least one of their moments of higher order, e.g. at least their moment of order 2, given by the variance σ²_{MD}.

Since faultless performance of the step is assumed for all reference runs RRi, the probability distribution PDF_{MD}(Δ_{MD}) of the residues Δ_{MD} to be expected during faultless performance of the step can be determined based on the dispersions of the residues Δⁱ_{MD} (tⱼ) between the measurement results MR^{RRi}_{MD} obtained by the respective measurement device MD during performance of the respective step and the corresponding fitted function f_{MD}(t, D_{MD}) determined for all reference runs RRi. In order to determine the probability distribution PDF(Δ_{MD}) of the residues Δ_{MD} to be expected during faultless performance of the step for a specific measurement device MD it can be tested mathematically, whether the distribution of all residues Δⁱ_{MD} determined for this measurement device MD throughout all reference runs RRi can be described by a known probability distribution function, e.g. a Gaussian or Weibull probability density function. To this extent, known tests, e.g. the Shapiro Wilk Test, for testing whether a data set exhibits a Gaussian distribution, can be applied.

In the example shown, the probability distributions of the residues Δⁱ_{La}, Δⁱ_{Lb}, Δⁱ_{Fa} determined for the first and the second level measurement device 19, 21 and the first flow meter 23 are Gaussian distributions. The corresponding probability density functions PDF_{La}(Δ_{La}), PDF_{Lb}(Δ_{Lb}) and PDF_{Fa}(Δ_{Fa}) are shown in FIG. 4a, 4b, 4c.

In case the probability distribution PDF(Δ_{MD}) of the residues Δ_{MD} is found to exhibit a known, but not Gaussian type of distribution, a data transformation, e.g. an iso-probabilistic transformation, is preferably performed, transferring the residues Δⁱ_{MD} (tⱼ) determined for all the reference runs RRi into to a coordinate system, wherein they exhibit a Gaussian distribution. Obviously, the same transformation will then later on have to be applied to the residues Δ_{MD} (tⱼ) determined during the monitored runs.

In case no known type of probability distribution function, suitable of describing the probability distribution PDF_{MD}(Δ_{MD}) of the residues Δ_{MD} determined for a measurement device MD can be found, an empirical probability distribution is used instead, which can be established based on the residues Δⁱ_{MD} determined for all reference runs RRi. Examples of such empirical probability distributions are shown in FIGS. 4d and 4e representing the normalized frequency distribution of the residues Δⁱ_{La}, Δⁱ_{Lb} determined based on the measurement results MRⁱ_{La}, MRⁱ_{Lb} of the first and the second level measurement device 19, 21 during performance of the second step during all reference RRi as a function of the size of the respective residues Δ_{La}, Δ_{Lb}.

During monitoring of a step the monitoring unit 25 will for each measurement device MD determine the second property K2 given by the dispersion of the residues Δ_{MD} (tⱼ) obtained based on the measurement results MR_{MD} of the monitored run and the corresponding fitted f_{MD}(t; D_{MD}), and compare it to the corresponding reference range R_{K2}.

The reference ranges R_{K2} for the second properties K2 are preferably determined based on a probability of a second property K2 determined during a monitored run, to belong to the corresponding probability distribution PDF_{MD}(Δ_{MD}) of the residues Δ_{MD} representative of faultless performance of the respective step. Like described above with respect to the first properties K1 of the primary models, a predetermined probability threshold can be applied, in order to determine each reference range R_{K2} for the respective second property K2, such that it will include all dispersions of residues Δ_{MD}, for which the probability to belong to the the corresponding probability distribution PDF(Δ_{MD}) of residues Δ_{MD} representative of faultless performance is larger than or equal to the predetermined probability threshold.

In case the probability distribution PDF(Δ_{MD}) of residues Δ_{MD} representative of faultless performance is a Gaussian distribution, or can be transformed into Gaussian distribution, e.g. by isoprobabilistic data transformation, the corresponding reference range R_{K2} can e.g. be defined as a reference range R_{K2a} for a variance σ²_{MD} of the dispersion of residues Δ_{MD} given by K2, comprising all variances σ²_{MD} of dispersions of residues Δ_{MD}, for which the probability to occur during faultless performance of the step is larger or equal to a predetermined probability threshold. These reference ranges R_{K2} are preferably determined based on F-Tests suitable of comparing variances of normally distributed populations.

In case the probability distribution PDF(Δ_{MD}) of residues Δ_{MD} representative of faultless performance is an empirical distribution, the reference range R_{K2} can be determined based on the Kolmogorov-Smirnov statistic by testing the hypothesis that a second property K2 given by the dispersion of the residues Δ_{MD} (tⱼ) corresponds to a distribution, which is identical to the corresponding distribution PDF(Δ_{MD}) of residues Δ_{MD} representing faultless performance of the step.

The probability of a second property K2 determined during monitoring to belong to the corresponding probability distribution PDF_{MD}(Δ_{MD}) representing faultless performance of the respective step of the process can be used to classify second properties K2 determined for monitored runs according to their probability of occurrence during faultless performance of the step. In case a second property K2 has a lower probability of occurring during faultless performance, there is a correspondingly higher probability, that a gradual change occurred, which may eventually lead up to fault. In this case the monitoring unit 25 can be set up to issue a corresponding warning.

In addition, tertiary models are set up for pairs of measurement devices MDa, MDb involved in the performance of the step, which render correlated measurement results MR_{MDa}, MR_{MDb} during faultless performances of the respective step. Each tertiary model comprises a third property K3, given by a degree of correlation Corr(MDa, MDb) between simultaneously obtained measurement results MR_{MDa}, MR_{MDb} of the respective pair of measurement devices MDa, MDb obtained during performance of the respective step of the process, and a corresponding reference range R_{K3}.

The most simple way to determine the degree of correlation between simultaneously obtained measurement results MR_{MDa}, MR_{MDb} of two different measurement devices MDₐ, MD_{b} during a single performance of a step during a monitored run of the process is given by calculating the corresponding correlation coefficient Corr(MDₐ, MD_{b}) given by:

$$Corr ( {MD}_{a} , {MD}_{b} ) = \frac{{\sum }_{j = 1 …n} ( {MR}_{MDa} ( {t}_{j} ) - \overline{{MR}_{MDa}} ) ( {MR}_{MDb} ( {t}_{j} ) - \overline{{MR}_{MDb}} )}{\sqrt{{\sum }_{j = 1 …n} {( {MR}_{MDa} ( {t}_{j} ) - \overline{{MR}_{MDa}} )}^{2} {\sum }_{j = 1 …n} {( {MR}_{MDb} ( {t}_{j} ) - \overline{{MR}_{MDb}} )}^{2}}}$$

wherein
tⱼ are the times at which the measurements were made during the respective run during performance of the step,
M̅R̅_̅{̅M̅D̅a̅}̅ denominates the average of all measurement results MR_{MDa}(tⱼ) obtained by measurement device MDa during the performance of the step during this run; and
M̅R̅_̅{̅M̅D̅b̅}̅ denominates the average of all measurement results MR_{MDb}(tⱼ) obtained by measurement device MDb during the performance of the step during this run.

In order to set up the tertiary models, those pairs of measurement devices MDa, MDb have to be identified, which render correlated measurement results MR_{MDa}, MR_{MDb} during faultless performance of the step. To this extend, the degree of correlation Corrⁱ(MDₐ, MD_{b}) of the measurement results MRⁱ_{MDa}, MRⁱ_{MDb} of each possible pair of measurement devices MDa, MDb during performance of the respective step of the process is determined for each of the reference runs RRi. For each pair of measurement devices MDa, MDb, the degrees of correlation Corrⁱ(MDa, MDb) determined for the respective pair during performance of the respective step for all reference run RRi render a reference distribution of the degrees of correlation Corr(MDa, MDb) to be expected during faultless performance of the step. In the most simple case, the degree of correlation Corr(MDₐ, MD_{b}) of a pair to be expected during faultless performance of the respective step can be determined to be equal to an average A(MDa, MDb) of the degrees of correlation Corrⁱ(MDₐ, MD_{b}) of the corresponding reference distribution of degrees of correlation.

Next, for each pair of measurement devices MDa, MDb it is determined, whether the average A(MDa, MDb) of the degrees of correlation Corrⁱ(MDₐ, MD_{b}) determined for this pair (MDa, MDb) is indicative of a significant degree correlation. This is preferably done by testing the hypothesis, that the average A(MDa, MDb) is unequal to zero by applying T-statistics methods originally developed by Students. Following these known methods, the average A is considered to be significantly different from zero in case an observed quantity t_{obs}(MDa, MDb), given by:

$${t}_{obs} ( MDa , MDb ) = \vert A ( MDa , MDb ) \vert \sqrt{\frac{m}{1 - {A ( MDa , MDb )}^{2}}}$$

wherein
m denominates the degrees of freedom given by p(n−2)
p equals the number of reference runs RRi, and
n equals the number of measurement results (MR_{MDa}(tⱼ), MR_{MDb}(tⱼ) obtained during each reference run RRi.
   exceeds a reference interval given by the T-Statistic with a given level of confidence.

Obviously more sophisticated methods of determining degrees of correlation, e.g. the calculation of joint probability density functions, can be applied to determine the degrees of correlation of measurement results MR_{MDa}, MR_{MDb} of pairs of measurement devices MDa, MDb, and to identify those pairs of measurement devices MDa, MDb, which render correlated measurement results MR_{MDa}, MR_{MDb} during faultless performance of the step.

Following this, the reference ranges R_{K3} for the degrees of correlation K3=Corr(MDa, MDb) of the correlated measurement device MDa, MDb are determined based on the respective reference distributions. Again, this is preferably done based on a probability for a degree of correlation K3=Corr(MDa, MDb), determined for a monitored run, to belong to the corresponding reference distribution.

The determination of the reference ranges R_{K3} and the comparison of the third properties K3 to the corresponding reference ranges R_{K3} is preferably performed based on the above mentioned T-Statistics. To this extent a coordinate transformation is applied transforming the degrees of correlation K3=Corr(MDa, MDb) into a coordinate system, wherein differences of degrees of correlation follow a standardized Gaussian distribution. The transformation is e.g. given by:

$$K {3}^{′} = \vert z - {ξ}_{0} \vert \sqrt{n - 3}$$

$$wherein$$

$$z = \frac{1}{2} ln ( \frac{1 + K 3}{1 - K 3} ) and {ξ}_{0} = \frac{1}{2} ln ( \frac{1 + A}{1 - A} )$$

In this coordinate system, the reference range R_{K3} can be easily defined, such that it includes all degrees correlations K3′ for which the probability to occur within the Gaussian distribution is larger or equal to the predetermined probability threshold. In consequence, a property K3 determined for a monitored run is found to exceed the reference range R_{K3} in case based, on the T-statistic, it is found to exceed the reference range R_{K3} determined based on the Gaussian distribution with a given level of confidence.

In the present example it is obvious, that the simultaneously obtained measurement results MR_{La}, MR_{Lb} of the two level measurement devices 19, 21 measuring the same level L present at the time inside the container 5 should be the same and thus be highly correlated. The corresponding distinct correlation pattern related to the performance of the first step is visualized in FIG. 5 showing each measurement result MRⁱ_{La}(tⱼ) of the first level measurement device 19 obtained during performance of the first step as a function of the simultaneously measured measurement result MRⁱ_{Lb}(tⱼ) of the second level measurement device 21 for a number of recorded reference runs RRᵢ.

An increase of the flow into the container 5 causes a the level inside the container 5 to rise quicker and vice versa. In consequence, the measurement results MR_{La}, MR_{Lb} of each of the level measurement devices 19, 21 and the simultaneously obtained measurement results MR_{Fa} of the flow meter 23 are correlated during the first step. A corresponding distinct correlation pattern is visualized in FIG. 6 showing each measurement result MRⁱ_{La}(tⱼ) of the first level measurement device 19 obtained during performance of the first step as a function of the simultaneously measured measurement result MRⁱ_{Fa}(tⱼ) of the flow meter 23 for several recorded reference runs RRᵢ.

In addition FIG. 7 visualizes the distinct correlation pattern of the correlation between the measurement results MRⁱ_{La}, MRⁱ_{LB} of the first and the second level measurement device 19, 21 during performance of the second step by showing each measurement result Laⁱ(tⱼ) of the first level measurement device 19 obtained during performance of the first step as a function of the simultaneously measured measurement result Lbⁱ(tⱼ) of the second level measurement device 21 for several recorded reference runs RRᵢ.

On more complex sites not all measurement results will be correlated. As an example measurement results of a ph-sensor measuring acidity of the product in the container 5 during the first step would not be correlated to the measurement results MR_{La}, MR_{Lb} of the level measurement devices 19, 21, nor would they be correlated to the measurement results MR_{Fa} of the first flow meter 23. Thus a visualization of the measurement results MRⁱ_{La}(tⱼ) of the first level measurement device 25 obtained during performance of the process step as a function of the simultaneously measured acidity for all recorded reference runs RRi would not exhibit a recognizable pattern.

For each pair of measurement devices MDa, MDb found to produce significantly correlated measurement results MR_{MDa}, MR_{MDb} during faultless performance of the step, a model of the corresponding correlation pattern to be expected during faultless performance of the step can be determined and recorded in the monitoring unit 25 as part of the tertiary model. These correlation patterns can be visualized in a diagram showing the measurement results MR_{MDa} of one of the measurement devices MDa of the respective pair as a function of the simultaneously obtained measurement results MR_{MDb} of the other measurement device MDb of the pair, and/or be described by a corresponding mathematical model representing the correlation pattern. The mathematical model can comprise a model function, describing the shape of the pattern, and/or mathematically determinable properties thereof.

Together, the primary, the secondary and the tertiary models pertinent to a step of the process provide a precise image of what is to be expected for a faultless performance of the step. Thus the performance of this step during a subsequent monitored run of the process on the site, can be monitored by the monitoring unit 25 based on this image. To this extent the measurement results MR_{MD}(tⱼ) obtained by the measurement devices MD involved in the present performance of the step are recorded in the same way as described above with respect to the measurement results obtained during the reference runs RRi. Based on the measurement results MR_{MD}(tⱼ) obtained during the present run, it is then determined, whether a deviation from the image of a faultless performance occurred, which is indicative of a fault. Thus a fault is indicated, in all cases where at least one of the properties K determined based on the measurement results MR^{PR}_{MD}(tⱼ) of the monitored run exceeds the corresponding reference range R_{K}.

Obviously, the size of the deviation caused by a certain type of disturbance, depends on the size of the disturbance. Whether a disturbance of a certain size is recognized by the monitoring unit 25 as a fault, depends on the impact of the disturbance on the monitored properties K in relation to the corresponding reference ranges R_{K}. Due to the combined use of the primary, the secondary and the tertiary models, the monitoring unit 25 is capable of detecting faults due to any disturbance large enough, to cause at least one of the properties K to exceed the corresponding reference range R_{K}.

As shown by the following examples of disturbances the combination of the three levels of monitoring provided by the primary, secondary and tertiary models form a powerful tool for detecting disturbances at a very early stage.

One example of a disturbance, which might occur during a disturbed run of the process is a leakage occurring during the first step of filling the container 3. This disturbance can be due to various root causes, e.g. due to a hole the container 3 or due to the valve 17 not closing properly. Due to the leakage the level L inside the container 3 does not rise as quickly as it should. In consequence the level measurement results MR_{La} obtained by the first level measurement device 19 during the disturbed run are lower than they should be and the slope of the fitted function f_{La}(t, D_{La}) fitted to these measurement results MR_{La} is lower than it should be. FIG. 1a shows one example of such measurement results MR_{La} indicated by triangles. The corresponding set of fitted coefficients D_{La} is indicated by a triangle in FIG. 2a. If the leakage is fairly small, it will have a small, hardly noticeable effect on the measurement results MR_{La} and the dispersion of residues Δ_{La} will not exceed the threshold R_{K2} shown in FIG. 3a. Also this disturbance does not affect the degree of correlation between the measurement results MR_{Fa}, MR_{La}, of the flow meter 23 and the first level measurement device 19, the measurement results MR_{Fa}, MR_{Lb} of the flow meter 23 and the second level measurement device 21, nor between the measurement results MR_{La}, MR_{Lb} of the first and the second level measurement device 19, 21. This type of disturbance does however have a larger effect on the slope d_{La1} of the fitted function f_{La}(t, D_{La}), which causes the set of fitted coefficients D_{La} indicated by a triangle in FIG. 2b to exceed the corresponding reference range R_{K2}.

Another example of a disturbance is a defective measurement device MD rendering non accurate measurement results MR_{MD}. Since this type of disturbance solely affects the measurement results MR_{MD} of the defective device, it will have a large impact on the degree of correlation between the measurement results MR_{MD} of the defective device and any other measurement device MD, which during faultless performance would render correlated measurement results MR_{MD}. Thus a reduced degree of correlation determined for a pair of measurement devices MD, which normally renders correlated measurement results MR_{MDa}, MR_{MDb}, during a monitored run is a clear indication of a disturbance pertinent to one of the measurement devices MD of the pair. In addition, depending on the size of the measurement errors, the properties K1, K2 determined based on the measurement results MR_{MD} of the defective measurement device MD will exceed the corresponding reference ranges R_{K1}, R_{K2} for the sets of fitted coefficients D_{MD}, and/or the dispersion of residues Δ_{MD}. Another example of a disturbance is a leakage occurring during agitation. Due to the agitation level measurement results MR_{La}, MR_{Lb} obtained during agitation show large fluctuations. Thus on the basis of the primary models, only larger leakages can be detected based on the reference ranges R_{K1} for the sets of fitted coefficients D_{La}, D_{Lb} for the level measurement devices 19, 21. A leakage will however have a much larger effect on the residues Δ_{La}, Δ_{Lb} between the measurement results MR_{La}, MR_{Lb} obtained by the level measurement devices 19, 21 and the corresponding fitted function f(t, D_{La}), f(t, D_{Lb}), and will thus be detected at a much earlier state based on the second properties K2.

### Model Testing and Risk Analysis

Once the model has been set up, and the properties K to be monitored as well as the corresponding reference ranges R_{K} have been determined, the effectiveness of the model with respect to the detection of faults caused by selected types of disturbances is preferably tested during a test phase. The selected types of disturbances are preferably those, that cause the most severe consequences.

If available, the selection can be made based on a failure mode cause and effects analysis (FMEA) or a failure mode cause and effects and criticality analysis (FMECA) performed for the site, listing types of disturbances, their consequences, as well as possible root causes and suitable remedies.

In order to determine the effectiveness of the monitoring with respect to a selected disturbance, the impact of the selected type of disturbance on the monitored properties K is analyzed in relation to the size of the respective disturbance. As can be seen from the examples described above, different types of disturbances will have different impacts on different monitored properties K. Whereas a certain type of disturbance may have a large impact on one or more of the properties K, it may have no or only a much smaller impact on other properties K.

The impact of a certain type of disturbance on the monitored properties K can be determined based on measurement results MR^{DR}_{MD} obtained during performances of disturbed runs DR of the process, during which a disturbance of this type has been voluntarily induced. In addition or alternatively corresponding measurement results MR^{DR}_{MD} to be expected during performances of the process suffering from the respective disturbance can be generated by numerical simulations. Based on measurement results MR^{DR}_{MD} of a sufficiently large population of disturbed runs DRi, suffering from a disturbance of the same size and type, disturbed primary, secondary and tertiary model are determined in the same way as the primary, secondary and tertiary models representing the faultless performance of the respective step were determined. This is repeated for increasing sizes of the same disturbance.

Next, the disturbed primary, secondary and tertiary models obtained for the different sizes of the same disturbance are compared to the corresponding models representing faultless performance of the step. Based on these comparisons, the impact of the disturbance on all three model levels can be analyzed in relation to the size of disturbance. This analysis is preferably performed by comparing the distributions of the properties K, namely the distributions of the sets of fitted coefficients D_{MD}, the probability distributions of the residues (PDF(Δ_{MD})) and the reference distributions of the degrees of correlation (Corr(MR_{MDa}, MR_{MDb})), determined based on the measurement results MRⁱ_{MD} of the reference runs RRi, to the corresponding distributions of the same properties K determined based on the measurement results MR^{DRi}_{MD} of a sufficiently high number of disturbed runs DRi, suffering from the disturbance of the same type and size. Based on the distributions of the properties K determined based on the measurement results MR^{DRi}_{MD} of the disturbed runs DRi suffering from increasing sizes of disturbances of the selected types and the reference ranges R_{K} determined for the monitored properties K based on the reference runs RRi, a confidence level a for detecting a fault, in case a disturbance of this type and this size or larger is present, can be determined. In addition, the corresponding probability p for not detecting a fault, even though a disturbance of this type and this size is present, can be determined.

### Monitoring and Validation

During normal operation of the site, the monitoring unit 25 will continuously monitor the steps of the process performed on the site. For each step, it will receive the measurement results MR^{PR}_{MD} of the measurement devices MD involved in the performance of the respective step, and will determined the corresponding properties K related to the primary, secondary and tertiary models of the respective step. If during monitored operation of the site at least one of the properties K exceeds the corresponding reference range R_{K}, the monitoring unit 25 will indicate a fault.

It is an advantage of the invention, that faults are detected immediately after completion of the respective step. This allows the operator to take immediate actions. In particular he can stop further processing of the intermediate product produced in this step, in order to avoid investing further production time and resources in further processing of the intermediate product, which after completion of the entire process would render an end product which does not comply to the quality standards required for it.

In case none of the properties K exceeds the corresponding reference range R_{K}, the performance of the step will be validated. In these cases, validation is granted immediately after performance of the respective step, ensuring the operator of the site, that this step was performed properly before time and resources are invested in further processing the result produced by the respective step. In addition, the reliability of granted validations can be quantified with respect to those disturbance, for which the model has been tested and the risk analysis has been performed, based on the respective confidence levels α for detecting a fault, in case a disturbance of the respective type and size or larger is present, and the corresponding probabilities β of not detecting a fault, even though a disturbance of one of the respective types and sizes is present.

In addition, the measurement results MR_{MD} obtained during validated performances of the respective step are preferably recorded as additional validated test runs, which can then be applied in the same way as the validated test runs performed during the preparatory phase, in order to refine the primary, secondary and tertiary models representing faultless performance of the step. In order to prevent gradual changes occurring on the site, which may eventually develop into a disturbance of noticeable size, to affect the model of the respective step, a number of validated test runs are collected, and it is tested whether the dispersions of the properties K determined based on the measurement results MR_{MD} of the validated test runs are compliant to the corresponding distributions of the previously stored model. If this is the case, the validated test runs are then considered as additional performed reference runs RRi, and the model is updated. Each update is performed in the same way as the original determination of the model for the step, based on a larger number of performed reference runs RRi, given by the newly obtained reference runs RRi and the reference runs RRi performed during the preparatory phase.

### Diagnosis

Since different types of disturbances have different impacts on the individual monitored properties K, the properties K determined for a monitored run of the step can not only be used for monitoring purposes, but can also be applied in order to determine root causes that caused the detected faults.

To this extent a diagnosing unit 31 is foreseen on the site, which can either be an integral part of the monitoring unit 25, comprise the monitoring unit 25, or be connected to it. The diagnosing unit 31 comprises a data base 33, for storing data sets related to known types of disturbances, which can occur during the monitored steps of the process. Each data set comprises a known type of disturbance and its impact on each of the monitored properties K. In addition each data set preferably comprises a list of one or more possible root causes, known to cause this type of disturbance. As described above, root causes causing a leakage are e.g. a hole in the pipe 9 or the container 3 or a maladjustment or failure of the valve 17. For each listed root cause, the data set preferably comprises a list of actions, comprising actions directed towards the determination whether the respective root cause is present, and preferably also a remedy suitable of resolving it.

Actions directed towards the determination, whether the root cause is present preferably include well-directed acquisition of further information, directed at enabling the diagnosing unit 31 and/or the operator of the site to determine whether it occurred. Such information may include information, which can be automatically or semi-automatically acquired by the diagnosing unit 31, e.g. by requesting a measurement device MD to perform a self-test and to provide the result thereof to the diagnosing unit 31, e.g. via the control unit 13, or by requesting an automatically operated valve to report its status. In addition such information may include information, that has to be acquired by an operator, who will then preferably provide a corresponding input to the diagnosing unit 31 via an interface of the diagnosing unit 31. As an example, the operator may be requested to check the status of a manually operated appliance, e.g. a pump or valve, or a passive component, e.g. a pipe or container.

In addition the diagnosing unit 31 comprises a computing unit 35 for performing the diagnosis described below, based on input provided by the monitoring unit 25 and the information stored in the data base 33. In addition the diagnosis can be based on input provided by the operator and/or input automatically or semi-automatically acquired by the diagnosing unit 31.

To begin with, the data base can be filled with data sets determined based on the information obtained during the test phase for the selected types of disturbances. To this extent the disturbed primary, secondary and tertiary models determined during the test phase for increasing sizes of the selected disturbances provide a detailed representation of the impact of the respective disturbance on the monitored properties K. In addition any other information available regarding further disturbances, root causes and related actions for the determination of their presence and/or remedies for resolving them, as well as additional diagnostic information, including rules for determining root causes can be added to the data base. Such information can e.g. be extracted from failure mode cause and effects analysis (FMEA) or a failure mode cause and effects and criticality analysis (FMECA) performed for the site, and/or from lists of error codes of possible errors associated with measurement devices capable of performing automatic self-diagnosis. The additional diagnostic information comprises e.g. diagnosing tools and/or methods available for the site or already applied on the site, including calculated or hand-crafted decision trees for the determination of root causes. This additional diagnostic information can for example be applied by the diagnosing unit 31 as supplemental information, for improving the diagnosing capabilities of any diagnosis performed based on the models and the monitored properties K, or as alternative diagnosing means or method, in those cases, where a diagnosis performed based on the models and monitored properties K does not render sufficiently good results.

If more than one measurement device MD of the same type is foreseen on the site, information contained in the data base concerning impairments of one of these devices, can be applied to the entire family. To this extend it can be copied or linked to the respective sections of the data base. Such information may include root causes causing impairments of the type of device, actions for the determination of their presence, remedies for resolving them, as well as any related additional diagnostic information stored with respect to the device.

During normal operation of the site, the monitoring unit 25 will continuously monitor the steps of the process performed on the site, determine the corresponding properties K related to the primary, secondary and tertiary models of the respective step, and indicate a fault, in case at least one of the properties K exceeds the corresponding reference range R_{K}. In case a fault is detected, a diagnosis can be performed. To this extend the properties K determined based on the measurement results MR_{MD} obtained during the faulty performance of the step are transferred to the diagnosing unit 31, which will then search the data base 33 for data sets stored for disturbances, which have an impact on the individual properties K, which matches the properties K determined for the present faulty performance of the respective step of the process.

In case at least one matching disturbance is found, the matching disturbances are indicated, and a root cause analysis is performed based on the matching disturbances. If already available in the data sets, the diagnosing unit 31 will assist this analysis by providing all root causes listed in the data sets of the matching disturbances. In addition any additional diagnostic information stored in the data base, in particular additional diagnostic information related to the matching disturbance, may be applied by the diagnosing unit 31, in order to determine further possible root causes. The diagnosing unit 31 will then preferably recommend the actions listed in the data sets, which are directed towards the determination, whether the respective root causes are present.

The diagnosing unit 31 will preferably provide the operator of the site with a suggestion for the most time and cost effective way to determine whether one of these root causes caused the detected fault. To this extend, the recommended actions are preferably recommended in an order corresponding to their availability and the time and cost involved in their performance. Recommended actions, which can be performed automatically, like for example a performance of a self-test of a measurement device MD, can be performed in a fully automated fashion based on a corresponding request issued by the diagnosing unit 31. Others have to be initiated and/or performed by the operator, who will then preferably provide the information obtained by their performance to the diagnosing unit 31.

If possible based on the information acquired by the recommended actions and the information provided by the data sets the diagnosing unit 31, will determine the root cause, and if available in the data set, indicate the remedy suitable to resolve it. Otherwise, the root cause and/or the suitable remedy will have to be determined by the operator, who will preferably provide the determined root cause and/or the suitable remedy to the diagnosing unit 31. In case this way a root cause and/or a remedy for it, is provided to the diagnosing unit 31, which is not already listed in the data set for the respective disturbance, the diagnosing unit 31 will then preferably amend the data base 33 by adding the respective root cause and/or the respective remedy to the corresponding data set. In case a newly added root cause was determined based on a diagnosis of a fault, for which at least two matching disturbances were found, the operator will be requested to determine the matching disturbance, which caused the detected fault, in order to enable the diagnosing unit 31 to store the new root cause in the data set related to this disturbance.

After application of the remedy, consecutive performances of the respective step are monitored, and the performance of the remedy is validated, in case no further fault was detected during a predefined validation time interval. During operation, a success rate for the application of a certain remedy to all cases where the root cause to be resolved by it was identified based on a fault detected based on properties K matching the respective type of disturbance can be determined. If the success rate is high enough, and based on a sufficiently high number of cases, the remedy can be established as a standard remedy for these cases, and if possible, applied automatically.

In case an applied remedy is validated, the measurement results MR_{MD} obtained during the faulty performance of the step can be used as a further disturbed run DRi, suffering from the diagnosed disturbance in order to refine the corresponding disturbed primary, secondary and tertiary models representing this disturbance, in order to obtain a more precise description of the impact of this type of disturbance on the monitored properties K.

In case the monitoring unit 25 detects a further fault, during the validation time interval, this can either be due to a new disturbance, which occurred in the meantime, or due to the fact, that the applied remedy was not successful. In this case, the operator is requested, to evaluate, whether the previously applied remedy was successful and to provide a corresponding input to the diagnosing unit 31. In case the previously applied remedy was not successful, it is possible,

a) that the root cause was not identified correctly,

b) that the root cause was identified correctly, but the corresponding remedy stored in the data for resolving this root cause is not suitable, or

c) that the detected fault occurred due to a different disturbance having the same or a similar impact on the monitored properties K.

In this case the operator is requested to determine which of the three cases a), b) c) occurred, and to provide a corresponding input to the diagnosing unit 31, which will then amend the data base accordingly.

In the first case a) it is possible, that a new root cause occurred, which causes one of the determined disturbances, but is not listed in the corresponding data set. In this case, the new root cause and preferably corresponding actions directed towards the determination of its presence, and a remedy suitable of resolving this new root cause will be added to the corresponding data set. In the second case b) the non-suitable remedy stored in the data set will be replaced by the suitable remedy determined by the operator.

In the third case c) the diagnosing unit 31 will add a new data set for the newly discovered disturbance determined by the operator, preferably comprising its impact on each of the monitored properties K, and preferably also comprising root causes known to cause this disturbance and actions related to these root causes, preferably including actions directed towards the determination of their presence and remedies suitable of resolving them. In order to determine the impact of the newly discovered disturbance, the measurement results MR_{MD} obtained during the performance of the respective step suffering from the newly discovered disturbance are preferably recorded as a disturbed run DR, which is then used in the same way as the disturbed runs were used during the testing phase, in order to determine disturbed primary, secondary and tertiary models for increasing sizes of the newly discovered disturbance which will then provide a detailed representation of the impact of the newly discovered disturbance on the monitored properties K.

In case no matching disturbance can be found, a guided root cause analysis can e.g. be performed based on predefined decision trees to be followed in order to determine the root cause. The use of decision trees is known in the art, and frequently used on industrial sites in order to determine root causes causing disturbances of various kinds. To this extent, any additional diagnostic information stored in the data base can be applied. Root cause analysis can be improved by applying the additional information available due to the present invention. Two very powerful methods of applying this additional information are described below, which can be used in combination or as separate alternatives.

According to the first method, it is determined which of the properties K pertinent to one of the primary, secondary or tertiary models exceeded the corresponding reference range R_{K}, and in which direction they exceeded them. If for example one of the first properties K1, given by the set of fitted coefficients D_{MD} determined for one of the measurement devices MD exceeded the corresponding reference range R_{K1} it can be determined, which of the fitted coefficients d_{MD1}, . . . , d_{MDk} were too high or too low. The direction, in which a property K exceeded the reference range can for example be determined based on deviation vector indicative of an angle and a distance between the respective property K and the center of gravity of the respective reference distribution provided by the model.

Next, for each property K, for which the direction in which it exceeded the corresponding reference range R_{K}, was determined, the data base is searched for disturbances which cause the same property K to exceed this reference range R_{K} in the same or in a similar direction. Based on this, root causes stored in the data base as possible causes of disturbances, which cause the properties K, which exceeded the corresponding reference ranges R_{K} during the faulty run, to exceed the corresponding reference range R_{K} in the same or a similar direction, are determined. Since the thus determined root causes cause the respective properties K to change in the same direction, there is a high probability, that one of them may be at least partially responsible for the presently detected fault. In this respect, the root causes are preferably indicated in an order of decreasing similarity between the direction in which the property K exceeded the reference range R_{K} and the direction in which the root causes cause this property K to exceed the reference range R_{K}. These root causes and the related actions for determining whether they occurred provide a good starting point for the root cause analysis. In addition these root causes provide an indication for the operator, which parts or aspects of the site may have caused the presently detected fault.

According to the second method, it is determined whether a property K1, K2, pertinent to one of the primary or secondary models exceeded the corresponding reference range K_{R1}, K_{R2}. A property K1, K2 pertinent to one of the primary or secondary models can exceed the corresponding reference range R_{K} due to an impairment of the corresponding measurement device MD, e.g. an impairment causing erroneous measurement results MR_{MD}, or due to a root cause affecting the quantity measured by the measurement device MD.

An impairment of a measurement device MD, which is large enough, to cause at least one of the properties K1, K2 pertinent to the respective primary or secondary model to exceed the corresponding reference range R_{K} will also reduce the degrees of correlation K3 between the measurement results MR_{MD} of the impaired measurement device MD and the simultaneously obtained measurement results MR_{MD} of all other measurement devices MD, which render correlated measurement results MR_{MD} during faultless performance of the respective step. Thus the diagnosing unit 31 will determine, whether any of the third properties K3 of the tertiary models defined for this measurement device MD shows a reduced degree of correlation. If this is the case, the diagnosing unit 31 will diagnose, that the fault is due to an impaired measurement device MD and indicate the impaired measurement device MD.

Based on this the operator can then identify the root cause of the impairment and find and apply a suitable remedy to resolve it. In order to support the operator in doing this and/or to automize this process as much as possible, the data base 33 preferably comprises a data set for each of the measurement devices MD involved, comprising a list of possible root causes for impairments of the respective measurement device MD, and preferably also corresponding actions, including actions directed towards the determination of the presence of the respective root causes and remedies suitable of resolving them.

In case a fault is detected, which caused at least one of the properties K1, K2 pertinent to the respective primary or secondary model pertinent to one of the measurement devices MD involved to exceed the corresponding reference range R_{K}, but did not cause a reduction of the degrees of correlation K3=Corr(MR_{MDa}, MR_{MDb}) between the measurement results MR_{MD} of this measurement device MD and the simultaneously obtained measurement results MR_{MD} of any other measurement device MD, which should render correlated measurement results MR_{MD} during faultless performance of the respective step, the diagnosing unit 31 will diagnose, that the fault is due to a root cause affecting the property measured by this measurement device MD.

Based on this the operator can then identify the root cause that affected the measured property and find and apply a suitable remedy to resolve it. In order to support the operator in doing this and/or to automate this process as much as possible, the data base 33 preferably comprises a data set for each measured property, comprising a list of possible root causes affecting this measured property, and preferably also corresponding actions, including actions directed towards the determination of the presence of the respective root causes and remedies suitable of resolving them.

To begin with, the lists of possible roots cause for impairments of the measurement device MD and the lists of possible root causes affecting the measured quantities can either be empty or contain previously known data. The data sets can then be gradually filled with further input, provided by the operator, every time he identifies a root cause causing an impairment of one of the measurement devices MD or a root cause affecting one of the measured quantities and finds and applies a suitable remedy to resolve it.

Every time a fault is diagnosed to be due to a root cause causing an impairment of the measurement device MD or a rout cause affecting one of the measured properties, the diagnosing unit 31 can then indicate the corresponding listed root causes a possible root causes, and the determination of the root cause, that caused the fault, and the determination and application of the suitable remedy can then be performed as described above with respect to faults, for which one or more matching disturbances were found.

After identification of a root cause affecting a measured quantity or causing an impairment of a measurement device MD and determination and application of the determined remedy it will then be determined whether the remedy was applied successfully during the validation time interval. In case no further fault was detected during the verification time interval, the application of the remedy will be validated.

In case the remedy was validated, the measurement results MR_{MD} obtained during the performance of the respective step suffering from the disturbance caused by the identified root cause, which was resolved by the validated remedy is preferably recorded as a disturbed run DR, which is then used in the same way as the disturbed runs were used during model testing.

In case the determined root cause caused a disturbance, for which a data set is already stored in the data base 33, it can be used as an additional disturbed run DR, in order to refine the already determined impact of the disturbance on the monitored properties K. In case the determined root cause caused a disturbance, for which no data set has been stored in the data base 33 yet, a new data set is added to the data base, and the disturbed run DR is used as a first disturbed run DR for determining of the impact of the newly added disturbance on the monitored properties K in the same way as described above.

Thus during operation, the data base will be gradually filled with more and more complete data sets related to a growing number of disturbances, enabling the diagnosing unit 31 to diagnose more and more disturbances, to identify a growing number of root causes and remedies suitable of resolving them.
1 first supply tank
3 container
5 inlet pipe
7 agitator
9 outlet pipe
11 receptacle
13 control unit
15 valve
17 valve
19 first level measurement device
21 second level measurement device
23 flow meter
25 monitoring unit
27 memory
29 computing unit
31 diagnosing unit
33 data base
35 computing unit

1-19. (canceled)

20. Monitoring means, for monitoring at least one step of a predefined process performed on an industrial site comprising means for running the process on the site, including a control unit controlling initiation and performance of steps of said process, and measurement devices involved in the performance of the steps for measuring process related quantities, comprising:
the monitoring unit designed to be set up and connected such that it has real-time access to measurement results obtained by said measurement devices involved in the performance of the steps to be monitored and the times at which they were obtained in relation to a starting time at which performance of the respective process step was started during the respective run, said monitoring unit comprising:
a memory storing a model for each step to be monitored, each model comprising: a) a primary model for at least some, in particular all measurement devices involved in the performance of the respective step, each comprising: a basic function of time and a set of coefficients representing a time dependency of the measurement results of the respective measurement device to be expected during faultless performance of the step, and a first property given by a set of fitted coefficients determined by best fitting the basic function to the measurement results obtained by said respective measurement device during a performance of the step, and a reference range for the first property; b) a secondary model for each of the primary models, each comprising a second property given by a dispersion of residues between the measurement results obtained by said respective measurement device during a performance of the step and the corresponding fitted function, and a reference range for the second property, and c) tertiary models for pairs of said measurement devices involved in the performance of the step, which render correlated measurement results during faultless performance of the step, each tertiary model comprising a third property, given by a degree of correlation between simultaneously obtained measurement results of the respective pair during performance of the respective step, and a reference range for the third property, wherein each of the reference ranges comprises a range for the respective property within which the respective property is expected to occur during faultless performance of the step; and
computing means for determining the properties pertinent to the primary, secondary and tertiary models based on the measurement results obtained by said measurement devices involved in the performance of the monitored steps during monitored runs of the process, and for detecting a fault, in case at least one of these properties exceeds the corresponding reference range.

21. A method of determining a model of a step of a process stored in the monitoring unit, comprising the steps of:
performing a number of test runs of the process and determining whether a result produced by the respective test run is compliant to predefined quality requirements;
recording the measurement results obtained by measurement devices involved in the performance of the respective step together with the times at which they were obtained in relation to a starting time at which the respective process step was started during the respective test run for all test runs, for which compliancy to the quality requirements was determined, as performed reference runs; and
determining the primary, secondary and tertiary models based on the measurement results of a population of reference runs, comprising the performed reference runs or the performed reference runs and simulated reference runs, obtained by simulations performed based on the measurement results of the performed reference runs, which generate measurement results of the measurement devices to be expected during faultless performance of the step.

22. The method according to claim 21, further comprising the step of: determining each primary model by:
determining the basic function f_{MD}, based on the time dependency of the measurement results obtained by the respective measurement devices during performance of the respective step during the reference runs; and
determining the reference range for each first property by:
determining a set of fitted coefficients for each reference run by best fitting the respective basic function to the measurement results obtained by the respective measurement device during performance of the step during the respective reference run;
based on a distribution of the determined sets of fitted coefficients, determining a probability of a first property determined during a monitored run to belong to this distribution; and
determining the reference range such, that it includes all first properties, for which the probability to belong to the distribution is larger than or equal to a predetermined probability threshold.

23. The method according to claim 21, further comprising the step of:
determining the reference range for each of the second properties by, for each reference range:
determining a dispersion of residues between the measurement results obtained by the respective measurement device during performance of the step during one of the reference runs and the corresponding fitted function determined for this measurement device for this reference run for each of the reference runs;
based on all determined dispersion of residues determining a probability distribution representing the probabilities of residues to occur during faultless performance of the step as a function of their size; and
determining the reference range such, that it includes all second properties, for which the probability to belong to the corresponding probability distribution is larger than or equal to a predetermined probability threshold, in particular by determining the reference as a range for a variance of the residues of the dispersion of residues.

24. The method according to claim 21, further comprising the steps of:
identifying pairs of measurement devices involved in the performance of the step which render correlated measurement results during faultless performance of the step, in particular identifying them by each possible pair of measurement devices involved in the performance of the step determining a degree of correlation between their simultaneously obtained measurement results during performance of this step for each reference run;
identifying the pairs rendering correlated measurement results based on the degrees of correlations determined for all possible pairs for all reference runs; and
for each identified pair, determining the reference range for the respective third property such, that it includes all respective third properties, for which the probability to belong to a reference distribution given by a distribution of the corresponding degrees of correlations determined for the respective pair for the reference runs is larger than or equal to a predetermined probability threshold.

25. A method of monitoring performance of a step of a predefined process performed on an industrial site comprising means for running the process on the site, including a control unit controlling initiation and performance of steps of the process, and measurement devices involved in the performance of the steps for measuring process related quantities, and monitoring means comprising a monitoring means, for monitoring at least one step of a predefined process performed on an industrial site comprising means for running the process on the site, including a control unit controlling initiation and performance of steps of said process, and measurement devices involved in the performance of the steps for measuring process related quantities, and monitoring means according to claim 20, having real-time access to measurement results obtained by the measurement devices involved in the performance of the steps to be monitored and the times at which they were obtained in relation to a starting time at which performance of the respective process step was started during the respective run, comprising the steps of:
recording the measurement results obtained by the measurement devices involved in the performance of the step during performance of the step;
based on the recorded measurement results determining the properties pertinent to the primary, secondary and tertiary models of the respective step; and
detecting a fault, in case at least one of the properties exceeds the corresponding reference range.

26. The method according to claim 25, further comprising the step of: indicating a warning in case at least one of the determined properties occurred in a range, which according to a distribution of the respective property, to be expected during faultless performance of the step, in particular a corresponding distribution of sets of fitted coefficients, a corresponding probability distribution of residues and a corresponding reference distribution of the degrees of correlation, has a low probability of occurring.

27. A method of determining an impact of a disturbance of a certain type on the properties of the model for a step of the process monitored by a monitoring unit, according to claim 20, the method comprising the steps of:
recording measurement results of the measurement devices involved in the performance of the step during disturbed runs of the process step, during which a disturbance of this type has been voluntarily induced, and/or generating corresponding measurement results to be expected during performances of this step suffering from the respective disturbance by numerical simulations;
determining disturbed primary, secondary and tertiary models in the same way as the primary, secondary and tertiary models representing the faultless performance of the respective step were determined based on recorded and/or generated measurement results of a population of disturbed runs suffering from disturbances of the same size and type;
repeating the determination of the disturbed primary, secondary and tertiary models for increasing sizes of the same type of disturbance; and
determining the impact of the type of disturbance on the properties of the model by comparing the distributions of the properties, in particular the distributions of the sets of fitted coefficients, the probability distribution of the residues and the reference distributions of the degrees of correlation, determined based on the measurement results of the reference runs to the corresponding distributions of the same properties determined based on the measurement results of the disturbed runs.

28. The method according to claim 25, further comprising the steps of:
validating performances of monitored steps during which no fault was detected; and
in particular validating them with a reliability determined based on a confidence level for detecting a fault, in case a disturbance of a certain type and this size or larger is present, and/or a probability of not detecting a fault, even though a disturbance of a certain type and this size is present, determined for one or more disturbances, for which disturbances their impact on the properties has been determined based on a method according to claim 27, and
for which disturbances the confidence level and/or the probability has been determined based on the distributions of the properties determined based on the measurement results of the disturbed runs suffering from increasing sizes of disturbances of this type and the reference ranges for the monitored properties.

29. Method according to claim 28, further comprising the steps of:
storing the measurement results obtained during validated performances; and
updating the model stored in the monitoring unit based on measurement results of validated performances of the respective step.

30. A diagnosing unit for performing diagnoses regarding faults detected by a monitoring means according to claim 20, the diagnosis unit, comprising:
a data base for storing data sets related to known types of disturbances, which can occur during performance of one of the steps for which a model is stored in the memory of the monitoring unit, wherein each data set comprises: the type of disturbance, and its impact on each of the monitored properties determined by a method according to claim 28.

31. The diagnosing unit according to claim 30, wherein:
at least one data set comprises: a list of at least one root cause, causing the respective disturbance, and in particular a list of at least one root cause and a list of at least one action for at least one of the listed root causes, in particular an action directed towards the determination, whether the respective root cause is present, and/or an action given by a remedy suitable of resolving the respective root cause.

32. A method of performing a diagnosis regarding a fault detected by monitoring means on an industrial site comprising a diagnosing unit, according to claim 30, the method comprising the steps of:
searching the data base for data sets stored for disturbances, which have an impact on the individual properties, which matches the properties determined for the present faulty performance of the respective step of the process; and
in case at least one matching disturbance is found, determining the root causes stored in the respective data sets, as possible root causes, which may have caused the detected fault, and performing the diagnosis based on the determined possible root causes.

33. A method of performing a diagnosis regarding a fault detected by monitoring means on an industrial site comprising a diagnosing unit, according to claim 30, the method comprising the steps of:
searching the data base for data sets stored for disturbances, which have an impact on the individual properties, which matches the properties determined for the present faulty performance of the respective step of the process; and
in case no matching disturbance is found, determining in which direction the properties, which exceeded the corresponding reference range, exceeded the corresponding reference range, for each property, for which the direction, in which it exceeded the corresponding reference range, was determined, searching the data base for disturbances which cause the same property to exceed this reference range in the same or a similar direction, determining the root causes stored in the data sets of the disturbances, which cause the respective properties to exceed the corresponding reference range in the same direction, as possible root causes; and
performing the diagnosis based on the determined possible root causes.

34. A method of performing a diagnosis regarding a fault detected by monitoring means on an industrial site comprising a diagnosing unit according to claim 30, the method comprising the steps of:
in case the first or the second property determined for one of the measurement devices involved in the performance of the step exceeded the corresponding reference range and one of the third properties related to a tertiary model pertinent to the same measurement device shows a reduced degree of correlation diagnosing a disturbance pertinent to this measurement device; and/or
in case the first or the second property determined for one of the measurement devices involved in the performance of the step exceeded the corresponding reference range and none of the third properties related to a tertiary model pertinent to the same measurement device shows a reduced degree of correlation diagnosing a disturbance affecting the quantity measured by this measurement device.

35. The method according to claim 32, performed on an industrial site comprising a diagnosing unit, according to claim 32, wherein
additional information is stored in the data base;
in particular information on additional disturbances, root causes, actions related to root causes and/or additional diagnostic information, in particular rules for determining root causes, diagnosing tools and/or diagnosing methods; and
the additional information is applied during performance of the diagnosis, in particular in order to determine the disturbance and/or the root cause that caused the detected fault.

36. The method according to claim 32, performing a diagnosis regarding a fault detected by monitoring means on an industrial site comprising a diagnosing unit in accordance with claim 35, comprising the step of:
determining the root cause of the detected fault based on the determined possible root causes and the actions directed towards the determination of their presence stored in the data base, by performing the actions in an order, in particular an order recommended by the diagnosing unit, corresponding to their availability and the time and cost involved in their performance, in particular by having at least one of those actions, which can be performed in an automated fashion on the site, performed in an automated fashion based on a corresponding request issued by the diagnosing unit and/or by having at least one of those actions initiated and/or performed by an operator of the site.

37. The method according to claim 32, further comprising the steps of:
determining the root cause, that caused the presently detected fault;
applying a remedy to resolve the root cause,
during a verification time interval monitoring consecutive performances of the step of the process, and
validating the applied remedy, in case no further fault was detecting during performances of the respective step during the verification time interval.

38. The method of amending the data base of a diagnosing unit, according to claim 30, by:
adding at least one data set related to a disturbance, which had occurred on the site and was subsequently identified, in particular a data set comprising an impact of this disturbance on the properties, in particular an impact determined by the steps of claim 27,
adding at least one root cause, causing one the disturbances contained in the data base, in particular root causes identified by the operator during operation of the site;
adding at least one action, related to one of the root causes listed in the data base, in particular an action identified by the operator during operation of the site;
for at least one property measured by one of the measurement devices adding a list of at least one root cause, in particular a list of at least one root cause and list of at least one action related to one of the root causes, affecting this measured property; and/or
for at least one of the measurement devices, adding a list of at least one root cause, in particular a list of at least one root cause and list of at least one action related to one of the root causes, causing an impairment of this measurement device.
